(19) United States
(12) Patent Application Publication
(10) Pub. No.: US 2004/0203964 A1
(43) Pub. Date: Oct. 14, 2004

(54) Tracking system and method thereof

(75) Inventors: Syed Mohammad Amir Husain, Austin, TX (US); Todd Leland Young, Austin, TX (US)

Correspondence Address: Edward J. Marshall, Simon, Galasso & Frantz PLC, P.O. Box 26503, Austin, TX, 78755-0503, US

(73) Assignee: Track 14 Inc.

(21) Appl. No.: 10/273,537

(22) Filed: Oct. 18, 2002

(51) Int. Cl. H04B 17/00; H04B 7/00; H04Q 7/00

(52) U.S. Cl. 455/500; 455/67.11

(57) ABSTRACT

A tracking system including multiple remote transmitters and a master receiver is disclosed herein. The tracking system is adaptable for use in tracking children, tracking inventory, and numerous other applications. Each of the remote transmitters transmits an electromagnetic signal having an identifying characteristic. The receiver uses the identifying characteristic of the transmitted signal to associate each received transmission with a particular transmitter. The receiver then determines the distance and direction of each transmitting unit from the master receiver, and displays that information, along with a notification, whenever a particular transmitting unit travels beyond a set notification distance from the master receiver.

### FIELD OF THE DISCLOSURE

This disclosure relates generally to tracking systems, and more particularly to systems for tracking multiple transmitters in communication with a master receiver.

### BACKGROUND

There are many systems currently in use for keeping track of objects and individuals, including systems to track prisoners on probation or under house arrest, stolen vehicles, air traffic, children, and myriad other objects. Some of these tracking systems require subscription to a tracking service that locates a person using global positioning satellite (GPS) technology in response to a subscriber's request for tracking information. Typically, the subscription service receives requests from the subscriber and provides requested tracking information to the over the Internet, by phone, or via another communication network. Unfortunately, however, some people hesitate before using a subscription tracking service because of the relatively high subscription or per-use fees.

Some tracking systems are tailored for use under specific circumstances, such as tracking a child. Many child tracking systems employ receiver-transmitter pairs; the transmitter is worn by the child and the receiver is carried by the child's parent. Whenever the child strays outside the range of the receiver, the receiver detects the loss of signal and generates an alarm. Unfortunately, most of these child tracking systems include only a single transmitter unit, or are otherwise unsuitable for tracking multiple children. In addition, conventional receiver-transmitter pairs provide limited information to the parent.

Considering the conventional tracking systems just discussed, parents who desire to keep track of their children's' locations are left with a choice between relatively expensive subscription tracking services, and less than adequate receiver-transmitter paired systems. What is needed, therefore, is a tracking system that provides improved tracking functionality without requiring the significant costs associated with subscription tracking services.

### BRIEF DESCRIPTION OF THE DRAWINGS

Various advantages, features, and characteristics of the present disclosure, as well as methods, operation and functions of related elements of structure, and the combination of parts and economies of manufacture, will become apparent upon consideration of the following description and claims with reference to the accompanying drawings, all of which form a part of this specification.

FIG. 1 is a block diagram illustrating a multiple transmitter tracking system according to an embodiment of the present disclosure;

FIG. 2 is a block diagram illustrating a method of determining the location of transmitters in a multiple transmitter tracking system according to an embodiment of the present disclosure;

FIG. 3 is a block diagram illustrating a method of extending the tracking range of a multiple transmitter system according to an embodiment of the present disclosure;

FIG. 4 is a flow diagram illustrating a method according to an embodiment of the present disclosure;

FIG. 5 is a diagram illustrating a transmitter unit according to an embodiment of the present disclosure;

FIG. 6 illustrates a receiving unit according to an embodiment of the present disclosure;

FIG. 7 illustrates a multiple transmitter system for use in inventory management according to an embodiment of the present disclosure; and

FIG. 8 is a block diagram of a receiver according to an embodiment of the present disclosure.

### DETAILED DESCRIPTION OF THE FIGURES

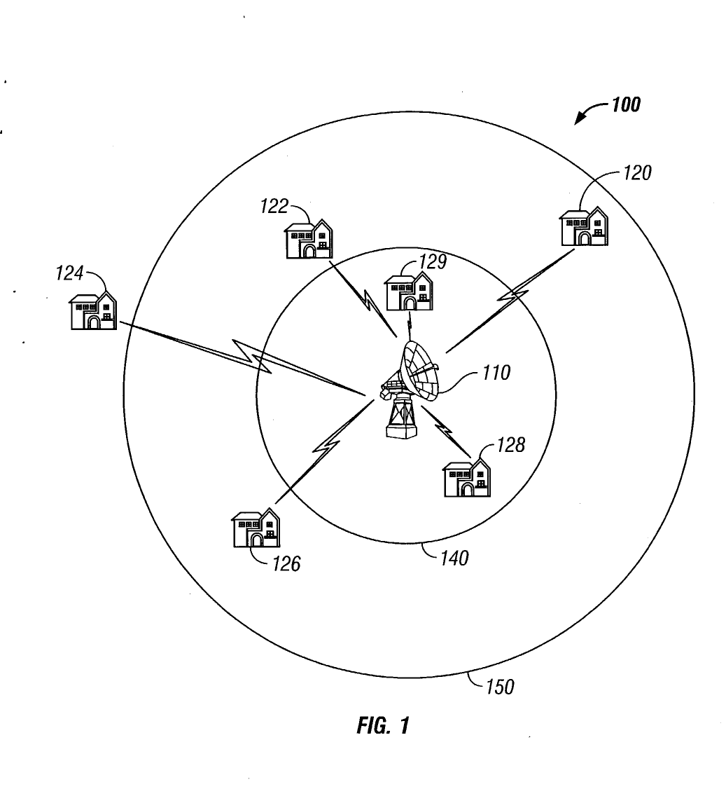

FIGS. 1-8 illustrate a tracking system employing multiple transmitters and a master receiver according to various embodiments of the present disclosure. The multiple transmitter system described herein can be used in a number of applications, such as keeping track of children, tracking inventory, and the like. For example, if the present system is employed to keep track of a family's children, each child can be given a transmitter. The transmitter carried by each child sends a signal back to the main receiver unit, which can determine the location of each child based upon the signal characteristics and/or information transmitted by each transmitter unit. Receivers according to various embodiments of the present disclosure determine both the distance of the child from the master unit and the direction of the child in relation to the master receiver. In at least one embodiment, a parent can set an alarm parameter so that an alarm is generated whenever a particular child moves beyond a set notification distance. This notification distance can be adjustable, either individually or globally so that the distance a first child is allowed to travel from the master receiver before generating an alarm can be limited to a distance less than the distance that a second child is allowed to travel before an alarm is generated.

When the tracking system disclosed herein is used by a parent to keep track of children, it may be advantageous to fashion the transmitter as an anklet, a bracelet, a belt, a backpack, a hair barrette or in another form that might induce a child to voluntarily wear the transmitter. In other embodiments, such as when the tracking system disclosed herein is used in inventory management, the transmitter may be miniaturized and placed inside of a packing label or some similar device that allows the transmitter to be easily affixed to containers and the like for use in a warehouse situation. A receiver according to the present disclosure may be constructed in the form of a portable hand-held device, as a base unit, or in any other suitable form.

Referring first to FIG. 1, a multiple transmitter system according to the present disclosure is illustrated, and is designated generally as System 100. System 100 includes Transmitters 120, 122, 124, 126, 128, 129 and Receiver 110. Each of the Transmitters 120-129 transmits a radio frequency signal that is received by Receiver 110. Receiver 110 can differentiate between the different transmitter units based on identifying characteristics of the signals transmitted by each transmitter. For example Transmitter 120 may transmit at a first frequency and each of the other transmitters may transmit at a frequency different from Transmitter 120 and from each of the other transmitters. Receiver 110 can then determine which transmitter generated a particular signal based on the frequency of the transmitted signal.

Rather than detecting unique transmission frequencies, Receiver 110 can identify the originating transmitter based on unique transmission patterns. For example Transmitter 120 may transmit continuously, while Transmitter 129 transmits in bursts. Likewise, each of the other transmitters may use a different transmission pattern, thereby enabling Receiver 110 to differentiate between multiple transmitters even when all transmitters are transmitting on the same frequency.

In yet other embodiments, Transmitters 120-129 may use digital transmissions with embedded identifiers. So, for example, Transmitter 126 may transmit an embedded code corresponding to its serial number or some other code, set either at the factory during manufacture or manually by a parent, that allows Transmitter 126 to be easily distinguished from any other transmitter. It will be appreciated that various different methods of distinguishing between multiple Transmitters 120-129 may be employed by those skilled in the art.

Once a signal is identified as belonging to a particular transmitter, receiver 110 can determine the location of the transmitter in relation to Receiver 110 by using one or more directional antennas. For example a signal transmitted from Transmitter 124 and received by three different antennas within Receiver 110 allows Receiver 110 to determine the direction of Transmitter 124 based on a difference in received signal strength between the antennas. Alternatively, a single manually or automatically movable directional antenna can be used in place of multiple directional antennas. The direction of any of Transmitters 120-129 can likewise be distinguished by Receiver 110 through the use of one or more directional antennas. It will be appreciated that while in the previous example Receiver 110 used three directional antennas, more or fewer antennas could be used consistent with the desire for exact direction determination, cost, or other similar factors.

Receiver 110 can also determine the distance to each of the Transmitters 120-129. In at least one embodiment, the distance to a particular transmitter is determined by the strength of the signal received from that transmitter. For example, the signal strength received by Transmitter 129 would be greater than the signal strength received from Transmitter 126, assuming that Transmitters 129 and 126 are transmitting with the same original signal strength.

Receiver 110 can be set to provide warnings when particular transmitters exceed particular notification distances. For example, if a parent controlling Receiver 110 determines that a first child carrying Transmitter 122 needs to remain closer to the parent than a second child carrying Transmitter 120, the parent can set Receiver 110 to generate an alarm when the child carrying Receiver 122 travels beyond Inner Ring 140, without generating an alarm when another child carrying Transmitter 120 is outside of Inner Ring 140. Likewise, the parent controlling Receiver 110 may set a notification distance for a child carrying Transmitter 124 so that whenever the child carrying Transmitter 124 travels beyond Outer Ring 150, Receiver 110 will generate a notification.

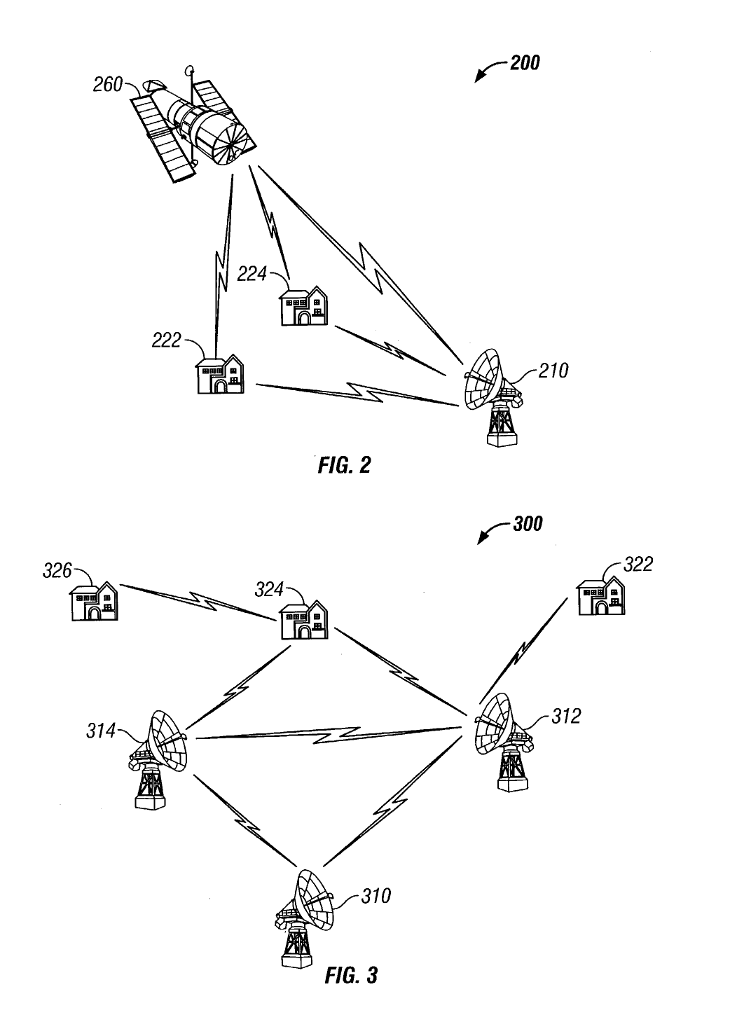

Referring next to FIG. 2, another embodiment of a tracking system is illustrated, and is designated generally as System 200. Reference numerals in FIG. 2 that are like, similar or identical to reference numerals in FIG. 1 indicate like, similar or identical elements or features. System 200 includes Receiver 210, Transmitters 222 and 224 and GPS Satellite 260. Receiver 210 and Transmitters 222, 224 include GPS receivers (not shown) to receive positioning information from GPS Satellites 260. Transmitters 222, 224 transmit their GPS coordinates to Receiver 210, which then uses the GPS coordinates to determine the distance and direction of Transmitters 222, 224 relative to receiver 210. It will be appreciated that the strength of received signals can be used as a backup or verification of the GPS distance determination without departing from the spirit and scope of the present disclosure.

Referring now to FIG. 3, another system according to the present disclosure will be discussed, and is designated generally as System 300. Reference numerals in FIG. 3 which are like, similar or identical to reference numerals in FIGS. 1 and 2 indicate like, similar or identical elements or features. System 300 includes Receivers 310, 312, 314 and Transmitters 322, 324, 326. The basic functionality of Receivers 310-314 and Transmitters 322-326 are the same as the basic functionality of Transmitters 1290-129, 222-224, and Receivers 110, 210 as previously discussed with reference to FIGS. 1 and 2. However, in System 300 Transmitters 322-326 and/or Receivers 310-314 are equipped with repeating circuitry that allows the tracking range of System 300 to be extended. For example assume that Transmitter 326 and Transmitter 322 are each being carried by a child belonging to the parent carrying Receiver 310. Further assume that Transmitters 322 and 326 are beyond the normal range of direct transmission to Receiver 310. In the illustrated embodiment, Transmitter 326 transmits its signal to Transmitter 324, and Transmitter 324 retransmits the signal received from Transmitter 326. Receivers 312, 314 receive the retransmitted signal from Transmitter 324 and deliver the retransmitted signal to Receiver 310. Likewise, Receiver 312 repeats the signal received from Transmitter 322 to Receiver 310.

In one embodiment, System 300 employs digital signals, and Transmitters 322 and 326 transmit GPS location information. When Receiver 310 receives the retransmitted signals, Receiver 310 can easily calculate the distance and direction of Transmitters 322 and 326 from Receiver 310. It will be appreciated that in order to prevent endless retransmission of received signals, any transmitter or receiver re-transmitting a signal may block processing of the same signal from any other source for a predetermined period of time. In at least one embodiment Receivers 312 and 314 may be repeaters set up at particular locations in malls, neighborhoods, etc., for the sole purpose of re-transmitting signals to Base Unit 310. However, in other embodiments Receivers 312 and 314 may be controlled by parents unassociated with the parent-controlling Receiver 310. In addition, it will be appreciated that not all transmitters and/or receivers need to be equipped with repeating circuitry.

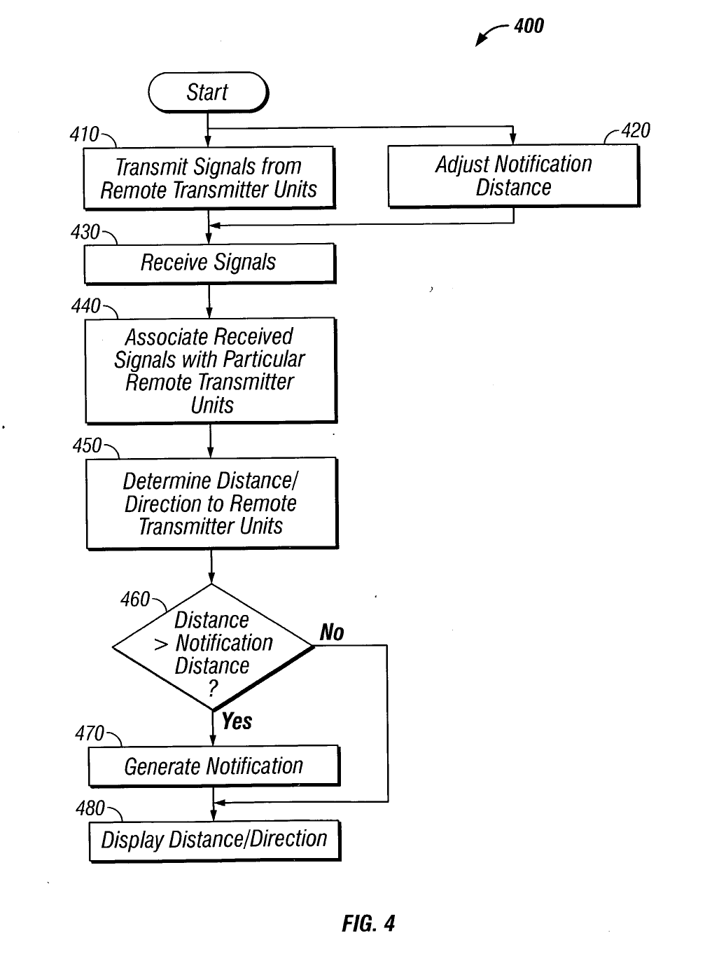

Referring next to FIG. 4 a method according to an embodiment of the present disclosure is illustrated and designated generally as Method 400. Method 400 begins at Step 410, in which signals are transmitted from remote transmitter units. Step 420, in which a notification distance is adjusted, can be performed concurrently with Step 410 as illustrated, or may be performed at any time prior to Step 460.

After the transmitted signals are received in Step 430, the receiver associates the received signals with particular remote transmitter units in Step 440. As discussed earlier, various methods may be used by the receiver to associate particular received signals with particular transmitters. For example, frequency differentiation used, transmission pattern differentiation, or information embedded in the transmitted signals can be used to associate received signal with a transmitter.

The method proceeds from Step 440 to Step 450, in which a receiver determines the distance and direction of the remote transmitter units in relation to the receiver unit. Various methods of determining the distance and direction have been previously discussed with reference to FIGS. 1-3.

After the distance and direction to the remote transmitter unit from the receiver unit have been determined, Method 400 proceeds to Step 450 to determined whether a distance notification should be generated. If the distance to the remote transmitter unit is greater than the notification distance set in Step 420, Method 400 proceeds to Step 470 and a notification is generated. If, however, the distance determined in Step 450 is less than or equal to the notification distance, then Step 460 causes Method 400 to bypass Step 470 and proceed directly to Step 480. Whether a notification is generated in Step 470 or not, Method 400 proceeds to Step 480 where the distance and direction determined in Step 450 are displayed on the tracking system's receiver.

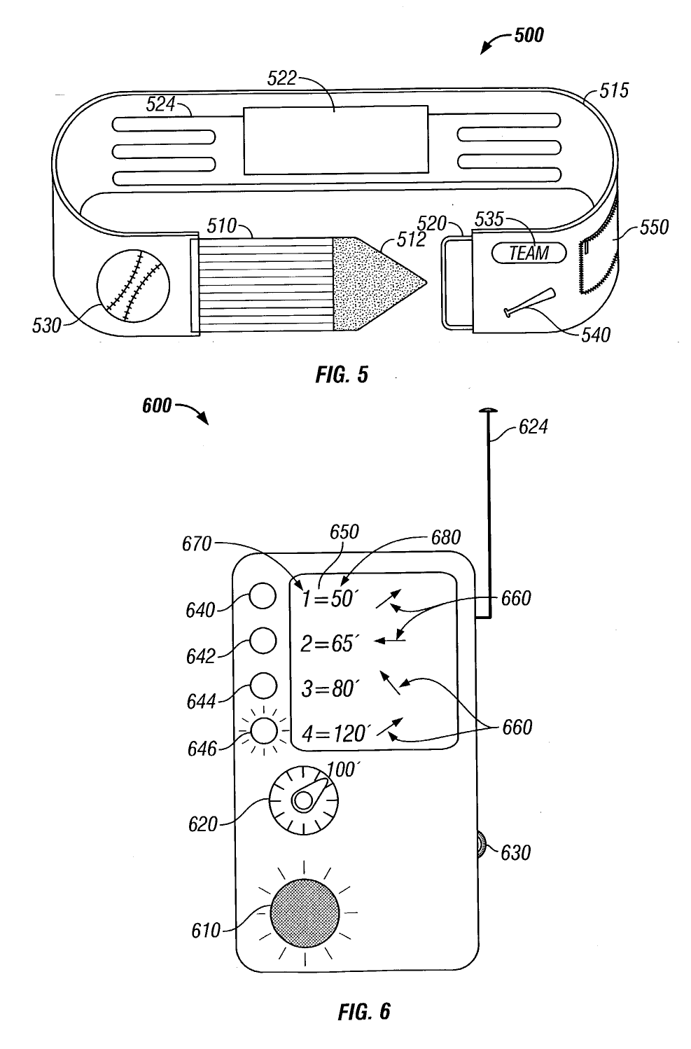

Referring next to FIG. 5, a transmitter unit suitable for use by a child is illustrated, and designated generally as Anklet 500. Anklet 500 includes Transmitter Portion 522 connected to Antenna 524. The combination of Transmitter Portion 522 and Antenna 524 provide the functionality used in implementing the tracking system disclosed herein. However, in order for any tracking system employing the methods disclosed herein to be effective for tracking a child, the child must carry the transmitter. Transmitter Portion 522 and Antenna 524 are may be sewn inside of or otherwise attached to Strap 515 such that Transmitter Portion 522 and Antenna 524 are not easily removed.

In addition to the functionality provided by Transmitter Portion 522 and Antenna 524, Anklet 500 includes decorations such as Sports Logos 530, 535, 540 and Zippered Pocket 550. Zippered Pocket 550 can be provided to allow a child to carry money, a house key or other necessary items discreetly, and to provide further incentive for the child to wear Anklet 500. Anklet 500 includes Loop Fastener 512 positioned on the end of Felt Strap 510. Loop Fastener 512 can be fed through Bracket 520 and pressed to Felt Strap 510 to securely hold Anklet 500 on the ankle or wrist of a child.

It will be appreciated that Anklet 500 is only one of many possible forms in which a transmitter can be carried by a child. Various different fastening methods may be used by those skilled in the art, and numerous different decorations, styles, and functional features can be used to increase the probability that a childe will desire to wear Anklet 500. It will also be appreciated that devices similar to Anklet 500 may be used to carry Transmitter Portion 522 and Antenna 524. For example, a bracelet, a hair barrette, a hat, a belt, a necklace or any other number of items can be fashioned according to the teachings set forth herein.

Referring next to FIG. 6, a receiver according to an embodiment of the present disclosure will be discussed, and is designated generally as Receiver 600. Receiver 600 includes Display 650, Indicators 640-646, Distance Dial 620, Volume Control 630, Speaker 610 and Antenna 624. Display 650 can display Remote Transmitter Unit Identifiers 670, Distance Indicators 680 distances associated with particular transmitters, as well as Direction Indicators 660.

In use, Distance Dial 620 can be adjusted to set a particular notification distance desired by a user. In at least one embodiment, Antenna 624 can be used in combination with Distance Dial 620 to extend or reduce the range selected using Distance Dial 620. For example, in one embodiment Dial 620 is set to 100 feet and Antenna 624 is retracted, causing a notification to be generated whenever one of the remote transmitter units travels a distance greater than 100 feet from Receiver 600. However, when Antenna 624 is extended, the same setting on Distance Dial 620 will generate a notification when the distance from a particular transmitter to Receiver 600 exceeds 200 feet. In the illustrated embodiment, the transmitter associated with Remote Transmitter Unit Identifier 4 is 120 feet away from Receiver 600 in a “2 o'clock” direction. Since the transmitter has exceeded the notification distance of 100 feet indicated by Distance Dial 620, LED Indicator 646 is illuminated, and Speaker 610 emits an audible notification.

Various audible, visual, and tactile notifications and combinations thereof can be employed consistent with the teachings set forth herein. For example an audible alert may sounded, a light emitting diode can be illuminated, a portion of Display 650 can flash, change color or in some other way attract the attention of a user of Receiver 600, a transducer (not shown) can be used to vibrate Receiver 600, etc. It will be appreciated that the intensity of some or all of the distance notifications may be controlled by use of Volume Control 630 or another suitable control mechanism.

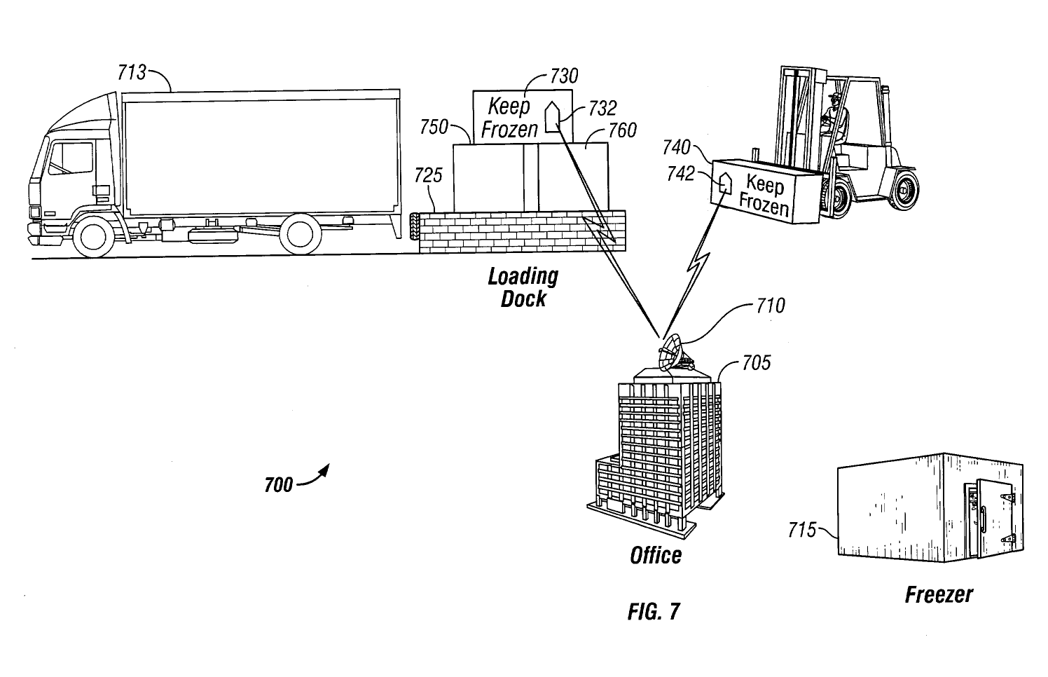

Referring next to FIG. 7 a tracking system according to an embodiment of the present disclosure will be discussed, and is designated generally as Tracking System 700. Tracking System 700 includes Receiver 710, which may be maintained in Office 705, and Remote Transmitters 732, 742 which can be attached to shipping or storage containers 730, 740.

In use, a Delivery Vehicle 713 may deliver Containers 730, 740 750, 760 to Loading Dock 725. Some containers, for example Containers 730, 740 may require special handling procedures, temperature controlled storage, or the like. Remote Transmitters 732, 742 are attached to Containers 730 and 740 using any of various suitable methods to track Containers 730, 740 and verify that the special handling requirements are met. As Container 730 and 740 are transported to Freezer 715, Receiver 710 tracks their location. For example, if one of the containers is left on Loading Dock 725 for too long, Receiver 710 would be aware of the situation and could notify appropriate personnel to take any action needed to ensure that the container is transported to Freezer 715 as quickly as possible.

A system as described herein also finds use in quality control applications. If a particular lot or group of items is found to be defective, for example a particular lot of perishable foods has spoiled, the tracking information received by Receiver 710 can be used to trace the movements of the affected lot, and can be used to aid in determining whether improper handling was a contributing cause of the spoilage.

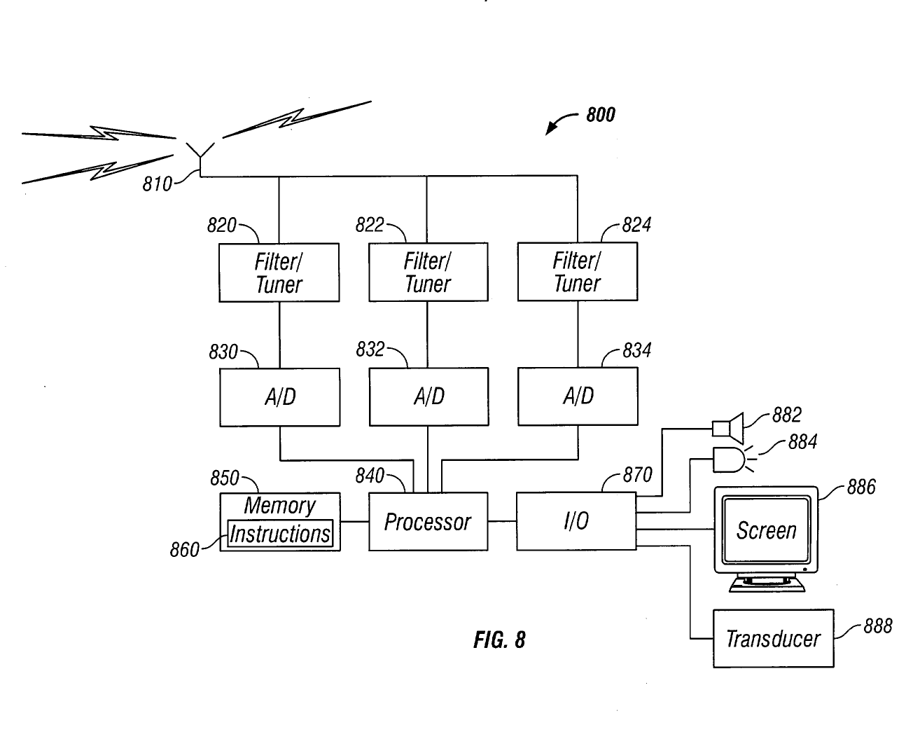

Referring next to FIG. 8 a block diagram of a receiver according to the present disclosure will be discussed, and is designated generally as Receiver 800. Receiver 800 includes Antenna 810, Filter/Tuners 820, 822 and 824, Analog to Digital Converters 830, 832 and 834, Processor 840, Memory 850, and I/O Device 870. Speaker 882, Lamp 884, Display Screen 886, and Transducer 888 are Connected to I/O Device 870.

Antenna 810 receives signals transmitted from multiple transmitters, each received signal having a unique frequency. Antenna 810 feeds the received signals to Filter/Tuners 820, 822 and 824, which are tuned to pass particular signal frequencies. Consequently, the signal passed to Analog to Digital Converter 830 is a filtered version of a signal from a first transmitter, while the signals passed to Analog to Digital Converters 832 and 834 are filtered versions of signals from other transmitters.

The Analog to Digital Converters 830, 832, and 834 convert the filtered signals into a format suitable for use by Processor 840. Processor 840 is controlled by a Program of Instructions 860 resident in Memory 850 that includes instructions to enable Processor 840 to determine the distance and direction of each transmitter from Receiver 800, and to generate a notification when appropriate. Processor 840 generates a notification by commanding I/O Circuitry 870, to operate Speaker 882, Lamp 884, Screen 886 or Transducer 888.

It will be appreciated that FIG. 8 represents only the most basic block diagram of a receiver according to the teachings set forth herein, and that various embodiments employ variations on the block diagram illustrated in FIG. 8. For example, only a single Antenna 810 is illustrated in FIG. 8, while certain embodiments employ multiple directional antennas in determining the direction of a remote transmitter from the Receiver 800. Additionally if only a single frequency is used by all of the multiple transmitters, multiple filter tuners and analog to digital converters would not be necessary, and Processor 840 would use information embedded in the signals from the remote transmitter units to differentiate between the different transmitter units.

In the preceding detailed description of the figures, reference has been made to the accompanying drawings, which form a part thereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical, chemical, and electrical changes may be made without departing from the spirit or scope of the disclosure. For example the above disclosure focuses primarily on a tracking system used by parents to keep track of their children, however the tracking system disclosed herein is adaptable to many different uses, and is not limited to use in a child of tracking situation. Accordingly, the present disclosure is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present disclosure is defined only by the appended claims.

What is claimed is:

1. A system comprising:
a plurality of transmitters configured to broadcast electromagnetic signals, the electromagnetic signals having an identifying characteristic;
a receiver to receive the signals from the plurality of transmitters, the receiver comprising:
a processor;
memory operably associated with the processor;
a program of instructions to be stored in the memory and executed by the processor, the program of instructions including instructions to:
associate particular signals received with particular ones of the plurality of transmitters based on the identifying characteristic of the signal;
determine distances between the plurality of transmitters and the receiver; and
generate a notification when one of the plurality of transmitters is farther from the receiver than a notification distance.

2. The system as in claim 1, wherein the receiver further includes a distance control to set the notification distance.

3. The system as in claim 1, wherein the identifying characteristic includes a frequency at which the electromagnetic signals are broadcast.

4. The system as in claim 1, wherein the identifying characteristic is a broadcast pattern.

5. The system as in claim 1, wherein the identifying characteristic includes an identification code included in the electromagnetic signals.

6. The system as in claim 1, wherein the receiver further includes a status display to indicate a status of the plurality of transmitters.

7. The system as in claim 6, wherein the status display includes a plurality of indicators, wherein particular ones of the plurality of indicators are associated with particular ones of the plurality of transmitters.

8. The system as in claim 7, wherein the indicators are light emitting diodes, and wherein the instructions to generate a notification include instructions to illuminate a particular diode when a particular one of the plurality of transmitters is farther from the receiver than the notification distance.

9. The system as in claim 1, wherein the receiver further includes a speaker, and wherein the instructions to generate a notification include instructions to generate an audible alarm using the speaker.

10. The system as in claim 1, wherein the receiver further includes a transducer, and wherein the instructions to generate a notification include instructions to generate a vibration alarm using the transducer.

11. The system as in claim 1, wherein the notification distance is adjustable to between about 6 feet and about 200 feet.

12. The system as in claim 1, wherein the receiver includes an extensible antenna, and wherein:
the notification distance is adjustable to between about 6 feet and about 50 feet when the antenna is unextended; and
the notification distance is adjustable to between about 50 feet and about 200 feet when the antenna is extended.

13. The system as in claim 1, wherein the electromagnetic signals include location information.

14. The system as in claim 13, wherein the plurality of transmitters include global positioning system circuitry.

15. The system as in claim 1, wherein the program of instructions includes instructions to determine a direction of the plurality of transmitters in relation to the receiver.

16. The system as in claim 15, wherein the receiver includes a plurality of directional antennas, and wherein the direction is determined based on a received signal strength at the plurality of antennas.

17. The system as in claim 1, wherein at least one of the plurality of transmitters is configured to be worn by a child.

18. The system as in claim 1, wherein at least one of the plurality of transmitters is an anklet.

19. A method comprising:
receiving, from a plurality of transmitters, electromagnetic signals having an identifying characteristic;
associating particular signals received with particular ones of the plurality of transmitters based on the identifying characteristic of the signal;
determining distances between the plurality of transmitters and the receiver; and
generating a notification when one of the plurality of transmitters is farther from the receiver than a notification distance.

20. The method as in claim 19, further including adjusting the notification distance.

21. The method as in claim 19, wherein the identifying characteristic includes a frequency at which the electromagnetic signals are broadcast.

22. The method as in claim 19, wherein the identifying characteristic is a broadcast pattern.

23. The method as in claim 19, wherein the identifying characteristic includes an identification code included in the electromagnetic signals.

24. The method as in claim 19, wherein generating a notification includes illuminating an indicator when one of the plurality of transmitters is farther from the receiver than the notification distance.

25. The method as in claim 19, wherein generating a notification includes generating an audible alarm.

26. The method as in claim 19, wherein generating a notification includes generating a vibration alarm.

27. The method as in claim 19, wherein the notification distance is adjustable to between about 6 feet and about 200 feet.

28. The method as in claim 19, wherein:
the notification distance is adjustable to between about 6 feet and about 50 feet when an antenna is unextended; and
the notification distance is adjustable to between about 50 feet and about 200 feet when the antenna is extended.

29. The method as in claim 19, wherein the electromagnetic signals include location information.

30. The method as in claim 29, wherein the location information includes global positioning system information.

31. The method as in claim 19, further including determining a direction of the plurality of transmitters in relation to the receiver.

32. The method as in claim 31, wherein the direction of the plurality of transmitters is determined based on a received signal strength at a plurality of antennas.

33. The method as in claim 19, wherein at least one of the plurality of transmitters is configured to be worn by a child.

34. The method as in claim 19, wherein at least one of the plurality of transmitters is an anklet.

35. A receiver comprising:
an antenna to receive electromagnetic signals from a plurality of transmitters, the electromagnetic signals having an identifying characteristic;
an analog-to-digital converter coupled to the antenna;
a processor coupled to the analog-to-digital converter;
memory operably associated with the processor;
a program of instructions to be stored in the memory and executed by the processor, the program of instructions including instructions to:
associate particular signals received with particular ones of the plurality of transmitters based on the identifying characteristic of the signal;
determine distances between the plurality of transmitters and the receiver; and
generate a notification when one of the plurality of transmitters is farther from the receiver than a notification distance.

36. The receiver as in claim 35, further including a distance control to set the notification distance.

37. The receiver as in claim 35, wherein the identifying characteristic includes a frequency at which the electromagnetic signals are broadcast.

38. The receiver as in claim 35, wherein the identifying characteristic is a broadcast pattern.

39. The receiver as in claim 35, wherein the identifying characteristic includes an identification code included in the electromagnetic signals.

40. The receiver as in claim 35, further including a status display to indicate a status of the plurality of transmitters.

41. The receiver as in claim 40, wherein the status display includes a plurality of indicators, wherein particular ones of the plurality of indicators are associated with particular ones of the plurality of transmitters.

42. The receiver as in claim 41, wherein the indicators are light emitting diodes, and wherein the instructions to generate a notification include instructions to illuminate a particular diode when a particular one of the plurality of transmitters is farther from the receiver than the notification distance.

43. The receiver as in claim 35, further including a speaker, and wherein the instructions to generate a notification include instructions to generate an audible alarm using the speaker.

44. The receiver as in claim 35, further including a transducer, and wherein the instructions to generate a notification include instructions to generate a vibration alarm using the transducer.

45. The receiver as in claim 35, wherein the notification distance is adjustable to between about 6 feet and about 200 feet.

46. The receiver as in claim 35, further including an extensible antenna, and wherein:
the notification distance is adjustable to between about 6 feet and about 50 feet when the antenna is unextended; and
the notification distance is adjustable to between about 50 feet and about 200 feet when the antenna is extended.

47. The receiver as in claim 35, wherein the electromagnetic signals include location information.

48. The receiver as in claim 35, wherein the program of instructions includes instructions to determine a direction of the plurality of transmitters in relation to the receiver.

49. The receiver as in claim 35, further including a plurality of directional antennas.
